(19) United States
(12) Patent Application Publication
(10) Pub. No.: US 2024/0087045 A1
(43) Pub. Date: Mar. 14, 2024

(54) Fault Tolerant Per Diem System

(71) Applicant: CREWFACILITIES.COM, LLC, Lakeway, TX (US)

(72) Inventors: George Kenny Tsakanikas, Fort Lauderdale, FL (US); Andrea Nicole Tsakanikas, Fort Lauderdale, FL (US)

(21) Appl. No.: 18/263,133

(22) PCT Filed: Feb. 24, 2022
(86) PCT No.: PCT/US22/17685

§ 371 Date: Jul. 26, 2023

Related U.S. Application Data
(60) Provisional application No. 63/150,020, filed on Feb. 16, 2021.

(51) Int. Cl. G06Q 40/12; G06Q 20/34; G06Q 20/40

(52) U.S. Cl. CPC G06Q 40/12; G06Q 20/34; G06Q 20/40145

(57) ABSTRACT

A system, method and apparatus for redundancy and reduction of device inoperability for payment authorization and documentation for allowing control of per diem expenses. Provision for failure of a transaction processing device before a transaction is completed is provided to ensure the transaction is not lost due to device failure.

### TECHNICAL FIELD OF THE INVENTION

The present invention relates to electronic payment transfer systems, and more particularly to implement control of and document payments of per diem allowances and the like to parties such as contractors, employees, or the like.

### BACKGROUND OF THE INVENTION

Organizations with employees who travel for their work or are working remote from their normal home base will often provide per diem allowances of payments for the employees to use, such as for food and lodging. It is important for the organizations to be able to ensure that the payments are used for authorized expenditures and to control the amounts that can be spent, so that the funds are not used for improper purchases and to avoid exceeding the maximum allowed daily amount. The organizations also need to manage the accounts from which the payments might be drawn, to ensure sufficient funds are available to avoid overdraft, while minimizing the amount of capital that is required. Also, it is important that payment transactions are properly documented with receipts so that the employer can comply with tax reporting. If payment is made without a proper receipt being obtained to show the payment was for an acceptable per diem expense, the payments can be classified by taxing authorities as employee income rather than expenses, which can result in tax compliance issues for an employer, since, for example, payroll withholdings may then be required for the payments, putting the employer in potential jeopardy for not having complied with tax withholding.

Different employees/contractors might have different needs and expenditure limits that should be available to them, so it can become difficult to ensure that expenditure limits are not exceeded.

Employees may be issued a payment card to use for their lodging and food transactions, and these are typically debited by use of a point of payment device. Many of the point of payment devices operate on rechargeable battery systems, and issues can arise if the batteries get too low while a transaction is in process, and the payment device shuts down, leaving the transaction only partially completed.

### SUMMARY OF THE DISCLOSURE

An employer or the like is provided with a control panel to allow setting of limits and expenditure types allowed to individual employees or contractors, or to groups of employees/contractors who might be working on a same project or at a same location. When an expenditure is incurred, the amount is deducted from the daily limit for the employee/contractor for the type of transaction. At the end of the day, unused fund amounts are rolled over for use on a subsequent day.

The invention effects an electronic payment transfer system that can be used by customers who provide per diem allowances to people (such as employees) in field and traveling. The allowances can be adjusted on a daily basis (or other time frame) and the amount of the allowances that are not spent in a 24 hour period are rolled back into the customer's (employer's) account. The per diem amounts can be designated and allocated to allow for particular types of transactions, such as for hotels, automobile rental/fuel, and/or restaurants, as examples.

The system further provides the employer/customer with transaction documentation for tax recording purposes for example, so if the employees do not get receipts, sufficient documentation receipts are provided automatically to ensure customer compliance with tax record requirements.

Embodiments provide a system, method and apparatus for redundancy and reduction of device inoperability for payment authorization and documentation for allowing control of per diem expenses for employees or contractors. Failure of a transaction processing device before a transaction is completed is accounted for to ensure the transaction is not lost due to device failure.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 is a block diagram of the operational system according to the invention;

FIGS. 2 and 3 illustrate the steps performed by communication device 110 in effecting a payment transaction;

FIGS. 4-6 illustrate the steps taken by the caching server at the service provider server 130;

FIGS. 7-8 illustrate the steps taken by the communications device 120;

FIG. 9 is a diagram of a dashboard process for setup of and control of per diem rules and accounts;

FIG. 10 is a flow chart of the steps in processing a per diem transaction;

FIG. 11 is a flow chart of account processing performed after the end of a day; and

FIG. 12 is a block diagram of an example first communication device or second communications device.

### DETAILED DESCRIPTION OF PREFERRED EMBODIMENTS

In the most general sense, the invention relates to a system employing a Travel Per Diem Card. The per diem card allows companies to manage and control per diem expense for employees and contractors. The company or other party that uses the system will employ an operational platform dashboard for programming cash values for each card based on individual needs of specific groups and individual travelers.

The card platform allows the company to upload specific cash value amounts to the card or an account that can be used on an automated daily basis. While the term “card” is used, it will be understood that a physical card is not required.

The company via the dashboard can adjust the amount available to each card in real time.

In a particular embodiment, the card is a 24-hour card which means basically that the amount programmed by the company for the individual traveler is only good for the value loaded on the platform for 1 calendar day, such as 12:01 am to 11:59 pm daily. There is no rollover of unused funds to the traveler. So, for example, if an employee is allotted $150 per day, $50 for food and $100 for hotels, and the employee uses $25 for food and $75 for the hotel, that leaves $50 available on the card. That $50 remains in the client company's available credit and does not roll over to the employee to still use the next day.

The system allows the company to determine which merchant codes can be programmed to each specific group or individual employee on the per diem card. (i.e., food can only be processed by restaurant merchants, lodging only by hotel merchants).

The system gives the option to the client company that they can pre-load cash into the company's account to cover the costs of the card operation or if applicable, the client company may choose to apply for credit for this card service.

The system allows companies to make adjustments in real time and also allows the client company to be able to choose which items they want to see on their dashboard. The card system offers a wide range of options where groups, lower tier employees, middle level management, upper level management and executive level employees per diem allowances and categories can all be adjusted separately.

The client company platform holder is able to monitor in real time their costs, fees and interest as the card and platform are being used.

The card system can have specifics on the use per transaction.

Each time the card is run or used a charge can be made that applies for an interchange fee (this covers the cost of the platform use and access).

The card system can also have a yearly or other time period cost charged to the company for maintenance.

Some embodiments of the system provide at least the following benefits to the client company:
(1) Real time accurate cost control on travel expenses.
(2) Client company has the ability to choose costs values in advance for groups or individuals.
(3) Client company has the ability to determine merchant codes for individual cards in real time.
(4) Accurate tax cost reimbursement, tax exempt or job cost reporting.
(5) Customizable reporting based on client company needs.
(6) No Rollover of unused per diem allocation after 24 hours, saving the client company on annual travel per diem expenditures, because in most companies a certain amount per day for meals/travel is allowed and simply added to their employees' paycheck, and if the employee does not use the amount, the unused amount is the employee's to retain as additional income.

Various embodiments may allow any of these features to be customized by a client company. For example, if a company choses, the system can allow some or all of the funds to roll over for a specified period of time. If a client company wants to group different types of expenses, the system can accommodate the client companies preferred groping of expenses and allocating expenses based on its preferred grouping.

Funds available for expenses on the per diem card may comprise actual funds in an account or available credit.

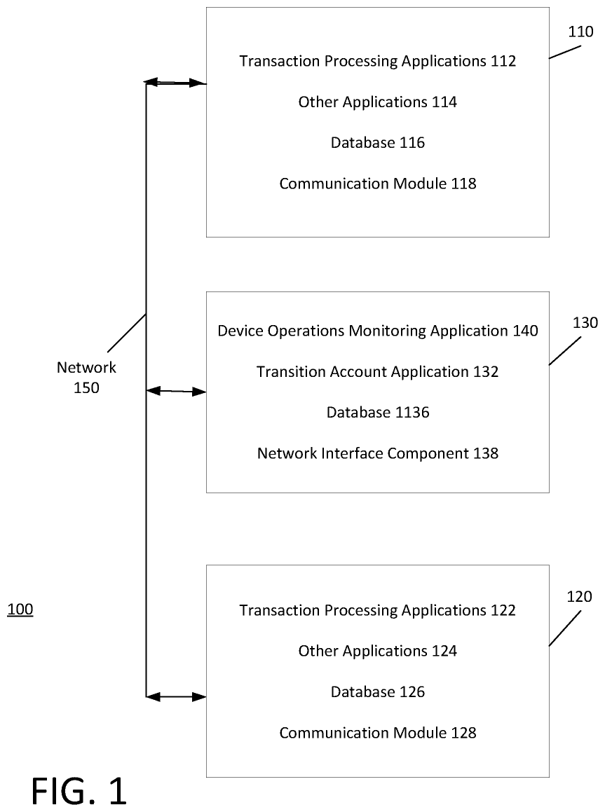

A preferred embodiment of the invention uses a system, method, and apparatus to effect an electronic payment transfer system, wherein with reference to FIG. 1, is a block diagram of the basic payment authorization system, where System 100 includes a first communication device 110, a second communication device 120, and a service provider server 130 which are in communication over a network 150. The first communication device includes transaction processing applications 112, other applications 114, a database 116 and communication module 118. The service provider server 130 includes device operations monitoring application 140, transaction account application 132, database 136 and network interface component 138. Second communication device 120, which may comprise a personal or business computer and is typically the financial institution's server, includes transaction processing applications 122, other applications 124, a database 126 and communication module 128. Each of the applications mentioned above carries out the steps described herein for the corresponding device.

The first communication device 110 is represented, for example, by a point of payment terminal or other device that allows an employee to present a payment card or the like to purchase services or goods allowed by the per diem expenditure rules the employer has set up. Second communication device 120 can be a terminal or device that the vendor of the per diem services uses to transfer earned funds to the vendor's account. Service provider server 130 represents a computer system that effects the processing of the per diem payment request and funds accounting.

Transaction processing application 112 may correspond to one or more processes to execute modules and associated devices of first communication device 110 to effect interaction with the user and payment card or other payment identification/information retrieval systems, including the ability to determine that first communication device 110 is failing, will become inoperable, or is in danger of failing or becoming inoperable during an electronic transaction processing operation or task with second communication device 120, and transmit data to service provider server 130 for use in completing the processing even when first communication device 110 is no longer available for processing interaction with service provider server 130.

Correspondingly, transaction processing application 122 and other applications 124 of communication device 120 may correspond to executable processes, procedures, and/or applications with associated hardware to effect interaction with the user and payment card or other payment identification/information retrieval systems. In other embodiments, first communication device 120 may include additional or different modules having specialized hardware and/or software as required.

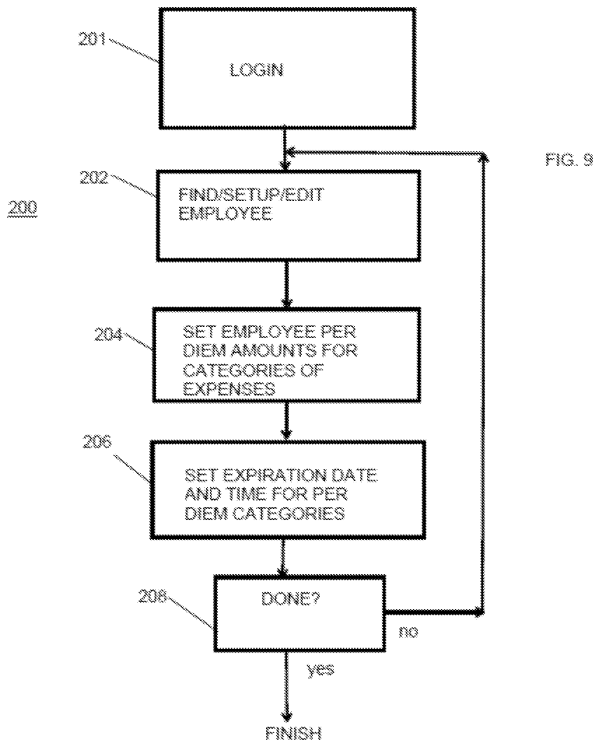

Prior to use of the system to process a per diem payment, the employer or party that is providing the per diem benefit to an employee or contractor will set up the payment amounts available and authorized categories. For example, if a daily limit is provided, the employer will employ a dashboard to set up per diem amounts and expirations. With reference to FIG. 9, a diagram of a dashboard process for setup and control of per diem rules and accounts, dashboard process 200 includes a login step 201, and upon logging in, provides the option to find/select/enter employee data function 202 to allow initial setup of an employee or groups of employees, and to edit employee/group information. The setup includes function 204 to set daily limits for per diem payments for an employee and/or groups of employees and may further allow subcategories of different types of per diem expenses and amounts allowed for each such type. For example, per diem expense amounts can be separately set for hotel, food, automobile, or other category limits. A single overall per diem expenditure may also be employed instead of having separate categories of expenditures, as an example. Different per diem data records can be employed for different days of the week also, as required to effect the payment rules and needs of an employer. An expiration date/time for the various per diem limits can be set, after which the per diem amounts are no longer available to the employee, in step 206. Also, a reset time frame defining when balances available to the employee are reset can be defined. Now that an employee or group is set up, the process can continue to select/set up additional employees at 208, or once the desired setup is complete, the process can end.

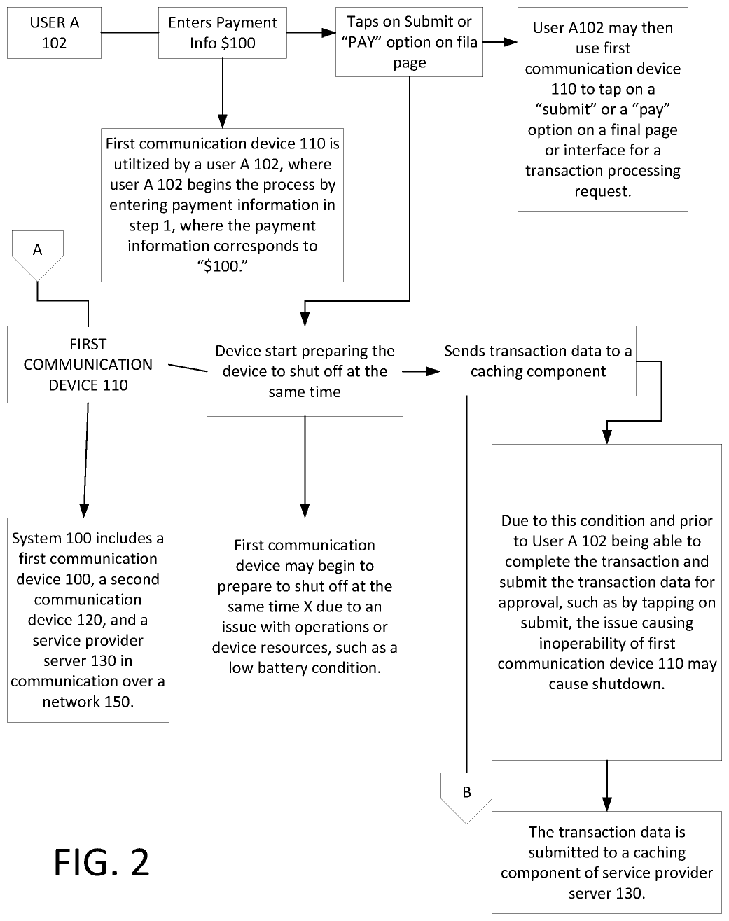

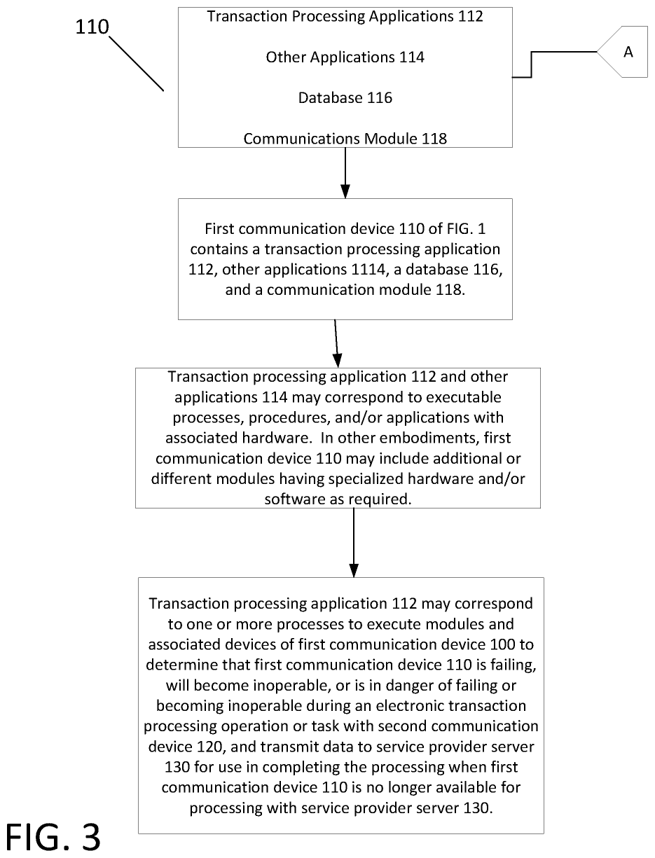

Referring to FIG. 2, a flowchart of operations steps at the beginning of a payment transaction for a per diem expense, User A 102 is present, who may be an employee or contractor working for an organization that is paying the per diem expense, where the User A is, for example, checking into a hotel or purchasing a meal, or other transaction as allowed under the per diem expense rules set by the employer. Using first communication device 110, the user enters payment information, such as at a point of sale terminal/credit card payment device, for an expense that the user wishes to charge, in this case $100. The point of sale terminal/payment device represents the first communication device 110 in this embodiment, utilized by User A 102. User A 102 begins the process by entering payment information in, where the payment information corresponds to the $100. The user selects Submit or Pay on the communication device which begins a transaction processing request for the payment to be effected, for account balances to be adjusted, for documentation to be generated and for payment to be transferred to the vendor.

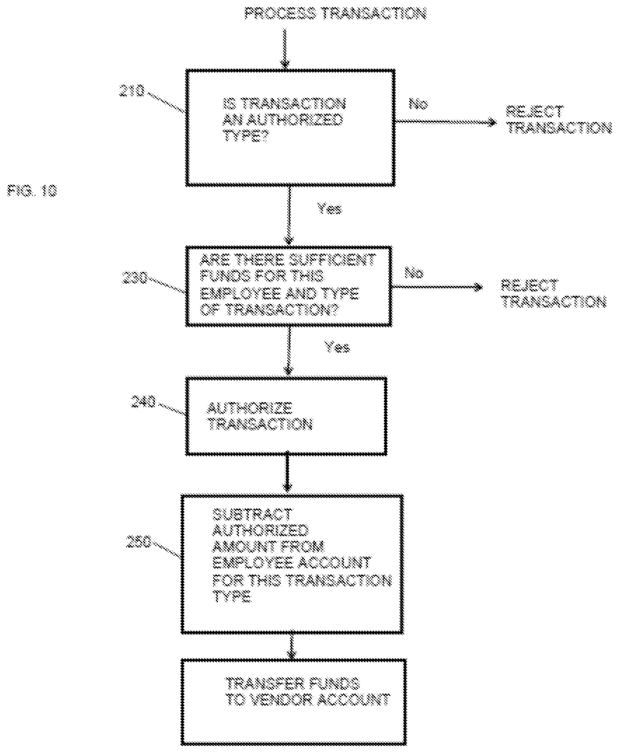

Basic payment operation is performed at the service provider server 130, comprising steps described in connection with FIG. 10, a flow chart of the payment transaction process, wherein on entry at block 210, a determination is made whether the requested payment is for an authorized type of transaction, such as for food/restaurant services or other allowed expenditure. For example, when a hotel runs a charge on an employee's card, the hotel's point of sale card processing machine sale machine will contact the financial institution server, which will then contact the service provider server 130 for approval. Alternatively, the hotel point of sale card processing machine can contact the service provider server 130 for approval first, and if approved, contact the financial institution network for processing the payment. If a payment is not an authorized transaction type, the transaction is denied and the payment processing is concluded. Some form of denial message may be returned to the point of sale.

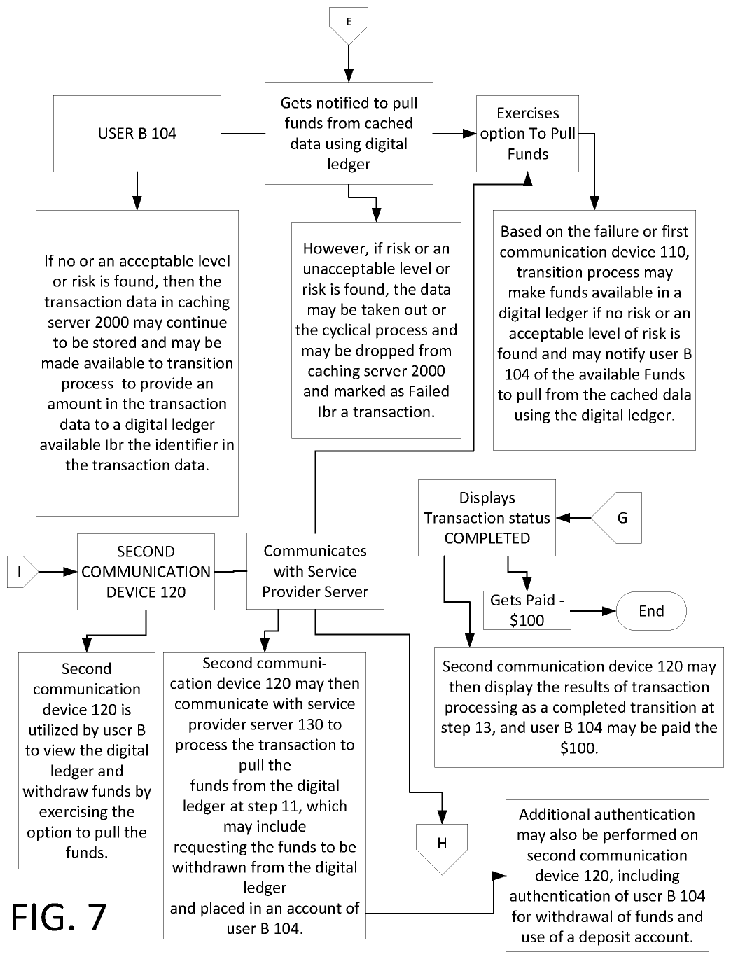

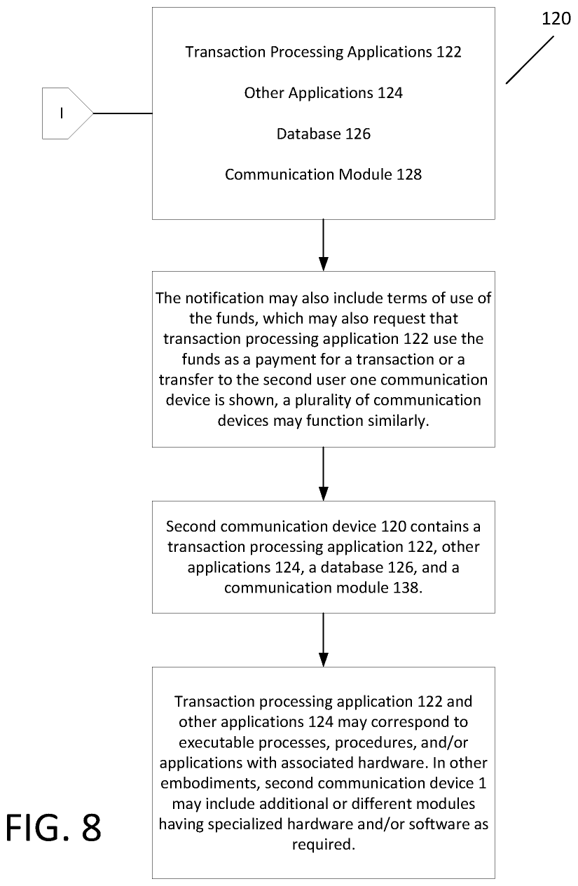

If the transaction is an authorized type, then processing continues to decision 230 where a determination is made whether the particular employee has sufficient per diem funds to complete the transaction. If yes, the transaction is authorized at 240, the transaction amount is deducted from the available funds amount for this employee at 250, and the authorization amount is transferred to an available amount available to the vendor of the per diem goods/services. The vendor's process for accessing the funds is discussed in connection with FIGS. 7-8 herein.

If insufficient funds are available, the transaction is denied. Alternatively, if some funds are available, a partial authorization of the transaction amount can be authorized at 240, and the partial amount deducted from the employee account (which would take the account balance to zero).

While the general discussion herein uses a period of one day for per diem expenditure amounts and authorization, other time frames can be employed, such as weekly or monthly, as needed based on the individual employer/employee situation and needs.

Referring again to FIG. 2, the process of dealing with a failing device 110 is described. On determination that the communication device 110 is failing after the user has tapped ‘PAY’, first communication device may begin to prepare to shut off at the same time as the user 102 has submitted a pay request, due to an issue with operations or device resources, such as a low battery condition.

If device operations monitoring application 140 detects that first communication device 110 has failed, device operations monitoring application 140 may utilize transition account application 132 to determine transaction risk in generating a transition account or ledger with funds from the users account and allow for withdrawal through second communication device 120.

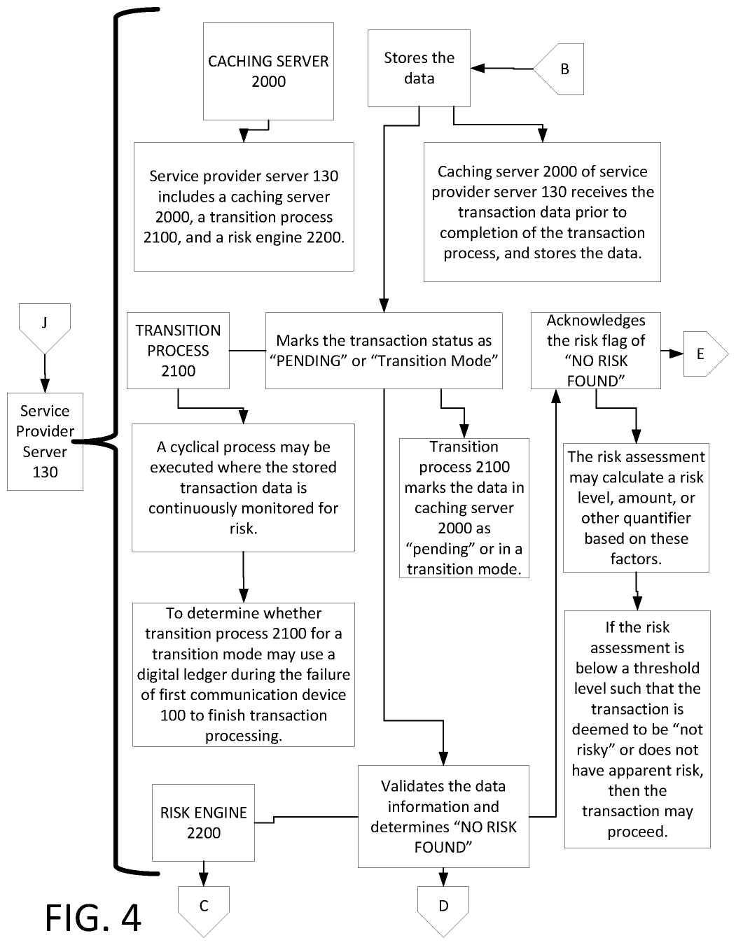

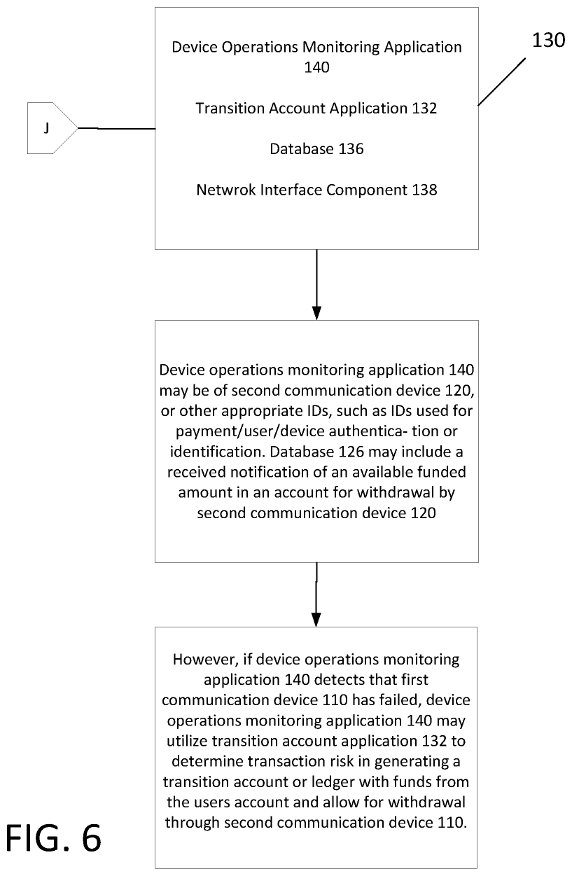

To ensure the transaction is not lost, transaction processing application 112 will send transaction data to a caching component at a caching server 2000 on the service provider server 130, for processing as discussed hereinbelow in connection with FIGS. 4-6. This step of sending data to the caching component can effectively rescue the transaction from being lost due to the failure of device 110. The Service provider 130 includes the caching server 2000, a transition process 2100 and a risk engine 2200.

Continuing now to FIG. 4 at B, the caching server 2000 at the service provider server 130 stores the transaction data that was sent by the first communication device 110 prior to completion of the transaction process, and marks the transaction status as “PENDING” or in a “Transition Mode”, and a transition process 2100 is begun. In the Transition Process, a risk assessment is performed to determine the risk of the transaction, which may be such risks as being fraudulent or invalid, to attempt to avoid paying in such case.

In the transition process 2100, cyclical operations may be executed where the stored transaction is continuously monitored for risk. A digital ledger may be used to finish the transaction processing during the failure of first communication device 100.

Risk Engine 2200 will use the information from the digital ledger to validate the transaction data, determining whether there is any risk, or if risk is present, whether the amount of risk is an acceptable level of risk. Risk assessment determines any risk factors that may be present, using such information as account balance, the time of the transaction request, the results of previous fraud assessments and/or whether previous fraud has been found for this particular account, previous fraudulent transactions by one or more parties in the transaction (such as the user or vendor), and the relationship between User A and User B (User B is another party discussed below). Other relevant data may also be employed in the risk assessment.

The risk engine 2200 returns a risk assessment level, amount or other quantifier based on the risk assessment factors, and if the risk assessment is below a threshold level such that the transaction is deemed to be “not risky” or does not have apparent risk, the transaction may proceed so that funds can be paid. If the risk level is unacceptable or risk is found, the transaction data is removed from the cyclical process of transition process 2100 and the transaction is dropped from caching server 2000 and marked as a failed transaction. If no or an acceptable level or risk is found, then the transaction data in caching server 2000 may continue to be stored and may be made available to transition process to provide an amount in the transaction data to a digital ledger of available funds for disbursement. The caching server will mark the transaction as “NO RISK FOUND” and processing continues with section E of FIG. 7, with second communication device 120 receiving notification of available funds.

The notification may also include terms of use of the funds, which may also request that transaction processing application 122 use the funds as a payment for a transaction or a transfer to an account of User B. User B in the illustrated example may comprise the vendor providing the goods/services to User A, such as a hotel or restaurant, for example.

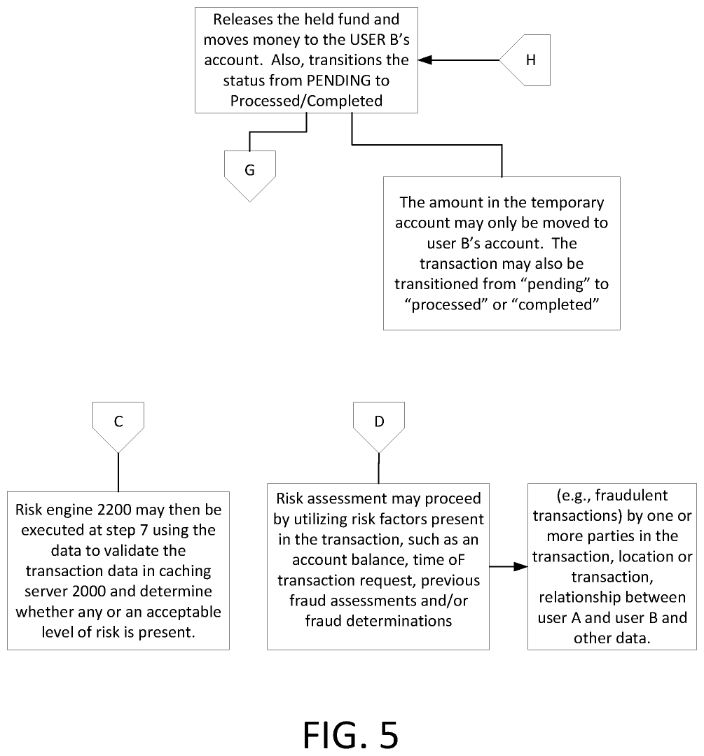

Continuing with Reference to FIG. 7, second communication device 120 communicates with the service provider server, and User B may exercise an option to pull funds to transfer to the user's account, and following arrow H to FIG. 5, the service provider server releases the funds and moves the amount to User B's account and transitions the status of the transaction from PENDING to Processed/Completed.

At second communication device 120, which represents, for example, a device used by User B to access funds earned by the payment process, and which communicates with Service Provider Server 130, User B 104 may use the device to retrieve funds from a transaction that was marked as acceptable level of risk, and a notification is provided to device 120 that User B can pull funds from cached data using the digital ledger. User B can exercise an option to pull funds whereupon processing continues through arrow H to FIG. 5, where the Service Provider Server 130 releases the held funds and moves the money to the User B's account and transitions the status from pending to “processed/completed”. The process continues then through arrow G to FIG. 7 where device 120 displays that the transaction is completed, the User B gets paid $100, and processing of the transaction is now complete.

Additional authentication may also be performed on second communication device 120, including authentication of User B 104 for withdrawal of funds and use of a deposit account.

In accordance with the above, device operations monitoring application 140 may be provided as part of second communication device 120, or other appropriate IDs, such as IDs used for payment/user/device authentication or identification. Database 126 may include a received notification of an available funded amount in an account for withdrawal by second communication device 120.

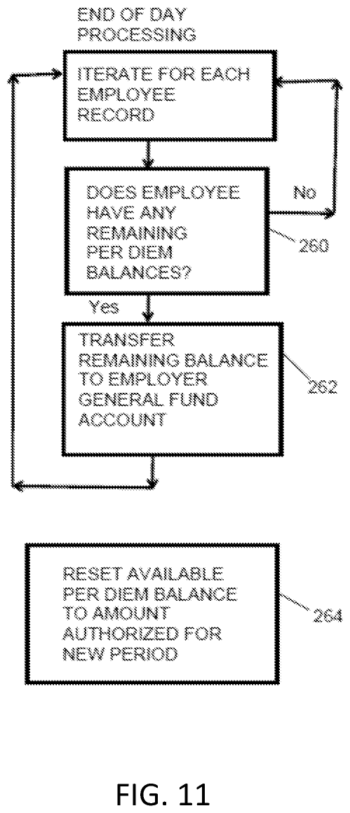

With reference to FIG. 11, a flow chart illustrating processing at the end of a day (or whatever per diem accounting period is being employed), for each employee account, a determination is made whether any per diem account balance remains that was not used (decision block 260). If funds remain, the amount remaining is allocated to the employer's general available funds balance account (block 262). In any event, if the employee is authorized for additional time periods of per diem expenses, then at block 264 the individual employee's allowed per diem amount is replenished to the value that the employer has authorized. These steps are performed for each employee per diem account.

While the example of payment described hereinabove employs a payment card such as credit, debit or pre-paid type card, other payment ‘devices’ can be employed, such as mobile payment or digital wallet service, or Biometrics authentication which will identify the User A 102 and allow the system to access the particular payment benefits authorized to that user. As used herein, the term “card” includes all such payment devices.

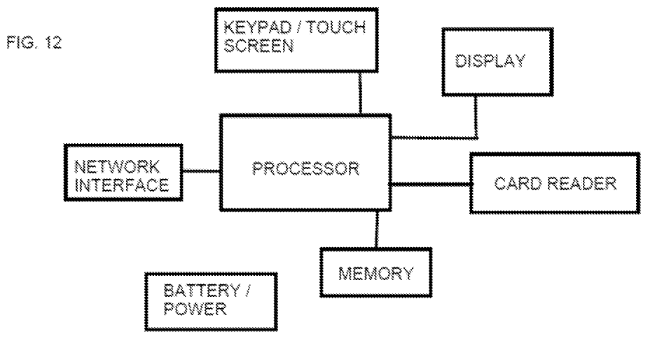

FIG. 12 is an example block diagram of hardware of a communication device 110, which can be a point of sale terminal or device. The device includes a processor for operating the device with memory (which may be ram/rom and/or storage device). A network interface is provided to communicate with service provider server 130. A display and keyboard/touch screen allow display of data an ability to provide input to the device and interactive display to the user. A card reader allows the payment card to be read for processing a transaction. This may comprise another type of identification interface, such as a biometric reader, barcode scanner (for scanning a code displayed on the employee's mobile phone, for example), a near-field communication (NFC) readers to accept “contact less” card payments, etc. Communication device 120 can be similar to communication device 110 and may comprise a computer or system that the user B employs to transfer funds. Device 120 might not include a card reader. Service provider server 130 can comprise a computer system with processor(s), memory, data storage, communication interface interconnected to interact with network 150 and function as a server and perform the operations discussed, as well as input/output devices such as keyboard/display.

While one each of communication device 110 and communication device 120 is shown in the examples and drawings, in use, a plurality of communication devices may be provided and function similarly with different users in different locations at the same or different times.

Accordingly, with the systems and methods described herein, a system for effecting per diem payment processing and control is provided to return unused funds to the employer and reset available balances to an employee at the end of the day or other period. The system also includes provisions to process transactions that are not fully completed due to failure of a transaction processing device.

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A method for providing tracking and controlling employee expenses, comprising:
providing an employee with an electronic per diem account;
making funds available to the employee in the electronic per diem account;
using a dashboard user interface, setting a spending limit for expenses allowed to be charged to the electronic per diem account and setting time limits for use of the available funds in the electronic per diem account; and
at an end of a per diem control time period, removing any remaining of the funds available in the electronic per diem account provided to the employee.

2. The method according to claim 1, wherein said setting a spending limit for expenses allowed to be charged comprises setting plural categories of types of expenses that can be charged to the electronic per diem account.

3. The method according to claim 2, further comprising setting separate individual spending limits for ones of the plural categories of types of expenses.

4. The method according to claim 3, further comprising, when the employee charges an expense, debiting the electronic per diem account if the expense is of a type authorized and if an amount of funds available to the employee for that type of expense is sufficient to cover the charge.

5. The method according to claim 1, further comprising providing an access means to the employee to access the per diem account.

6. The method according to claim 5, wherein said access means comprises a payment card.

7. The method according to claim 5, wherein said access means comprises a bio metric data.

8. The method according to claim 1, wherein the per diem control time period comprises 24 hours.

9. A system for providing tracking and controlling employee per diem expenses, comprising:
an electronic per diem account, into which funds are made available to the employee;
a dashboard user interface for setting a spending limit for expenses allowed to be charged to the electronic per diem account and for setting time limits for use of the available funds in the electronic per diem account; and
an end of a per diem control time period process for removing any remaining of the funds available in the electronic per diem account provided to the employee at the end of the per diem control time period.

10. The system according to claim 9, wherein said spending limit for expenses allowed to be charged comprises plural categories of types of expenses that can be charged to the electronic per diem account.

11. The system according to claim 10, wherein said spending limit for expenses allowed to be charged comprises separate individual spending limits for ones of the plural categories of types of expenses.

12. The system according to claim 11, further comprising, when the employee charges an expense, debiting the electronic per diem account if the expense is of a type authorized and if an amount of funds available to the employee for that type of expense is sufficient to cover the charge.

13. The system according to claim 9, further comprising an access means to the employee to access the per diem account.

14. The system according to claim 13, wherein said access means comprises a payment card.

15. The system according to claim 9, wherein said access means comprises a bio metric data.

16. The system according to claim 9, wherein the per diem control time period comprises 24 hours.

17. A system for redundancy and reduction of device inoperability in a per diem payment authorization system, comprising:
a point of payment processing device for interacting with a first user to effect a payment process, said point of payment processing device including failure detection for determining a possibility that the payment processing device may fail before completion of a transaction; and
a service provider server for receiving data concerning the transaction from the point of payment processing device via a network,
wherein upon determination of the possibility of failure, the point of payment processing device transmits transaction data to the service provider server prior to failure and the service provider server determines a risk level for the transaction to determine whether to accept the transaction and effect payment based thereon.

18. The system according to claim 17, further comprising identification service for identifying the first user for determining per diem benefits available to the first user.

19. The system according to claim 18, wherein the identification service comprises a payment card.

20. The system according to claim 18, wherein the identification service comprises a digital wallet.

21. The system according to claim 18, wherein the identification service comprises a biometric identification device.

22. The system according to claim 17, wherein the service provider server determines a risk level based on one or more risk factors selected from the group consisting of: an account balance, a time of transaction, a previous fraud assessment record, and a previous fraud determination.

23. The system according to claim 17, further comprising a payment transfer device for allowing a second user to obtain the payment effected by the payment process.

24. A method of providing redundancy and reduction of device inoperability in a per diem payment authorization system, comprising:
providing a point of payment processing device for interacting with a first user to effect a payment process, said point of payment processing device including failure detection for determining a possibility that the payment processing device may fail before completion of a transaction; and
providing a service provider server for receiving data concerning the transaction from the point of payment processing device via a network,
wherein upon determination of the possibility of failure, the point of payment processing device transmits transaction data to the service provider server prior to failure and the service provider server determines a risk level for the transaction to determine whether to accept the transaction and effect payment based thereon.

25. The method according to claim 24, further comprising identification service for identifying the first user for determining per diem benefits available to the first user.

26. The method according to claim 24, wherein the identification service comprises a payment card.

27. The method according to claim 24, wherein the identification service comprises a digital wallet.

28. The method according to claim 24, wherein the identification service comprises a biometric identification device.

29. The method according to claim 24, wherein the service provider server determines a risk level based on one or more risk factors selected from the group consisting of: an account balance, a time of transaction, a previous fraud assessment record, and a previous fraud determination.

30. The method according to claim 24, further comprising transferring a payment for a second user to obtain the payment effected by the payment process.
